(19) United States
(12) Patent Application Publication
(10) Pub. No.: US 2013/0337113 A1
(43) Pub. Date: Dec. 19, 2013

(54) CARBONATED DAIRY NUTRIENT BEVERAGE AND METHOD OF MAKING A CARBONATED DAIRY NUTRIENT BEVERAGE TO SUPPLY THE SAME QUALITATIVE NUTRITION CONTAINED IN SKIM MILK TO THE HUMAN DIET

(71) Applicants: George H. Clark, Woburn, MA (US); Mary Ann Clark, Woburn, MA (US)

(72) Inventors: George H. Clark, Woburn, MA (US); Mary Ann Clark, Woburn, MA (US)

(21) Appl. No.: 13/525,566

(22) Filed: Jun. 18, 2012

(51) Int. Cl. A23C 9/14; A23C 9/12

(52) U.S. Cl. 426/42; 426/569

(57) ABSTRACT

Carbonated dairy nutrient beverage solutions that supply essential nutrients in the human diet. The solutions may contain per 8 oz., calcium, magnesium and potassium ions in the form of salts, vitamins A Palmitate, D3, C, and optionally lutein, zeaxanthin and folic acid in specified amounts to provide dietary supplementation. Sweeteners, stabilizers and flavors can also be added to enhance flavor, sensory appeal, mouth-feel, ingredient solubilization and product appearance. A method of making the beverages is also described. A method of using Carbon Dioxide, Nitrogen and Argon gases to reduce sodium content, bacterial counts and reduce degradation of essential nutrients in dairy beverages with or without Pasteurization is also disclosed.

### FIELD OF THE DISCLOSURE

This disclosure relates to supplemented carbonated dairy nutrient beverages for the supplementation of essential nutrients in the human diet. This disclosure further relates to a method for producing carbonated dairy nutrient beverages that improves the suppression of bacterial cultures and spores to greatly extend product shelf life and to enhance the sensory appeal of dairy products to populations who do not like or drink milk. The beverages are designed for consumption by individuals of all ages to provide the same qualitative nutritional value of skim milk in addition to supplemental amounts of essential vitamins, amino acids, minerals and trace nutrients essential in the everyday diet.

### BACKGROUND OF THE DISCLOSURE

It is now well known that good nutrition is essential to the process of bone physiology and the maintenance of a state of health in children and adults. Poor dietary habits will prevent normal bone development in childhood and early adulthood and are directly associated with childhood obesity, which can result in cardiovascular disease, diabetes and respiratory disorders. These poor habits can contribute further to bone and teeth softening and can accelerate bone loss with advancing age.

Milk has long been recognized as an excellent nutritional source of essential minerals such as calcium and potassium, high quality protein and vitamins such as D, A, B₂, B₁, B₆ and B₁₂. Proper levels of these elements are essential in the diets of children, adolescents and adults for the development and maintenance of a healthy lifestyle. Such elements also assist in and promote healthy pregnancies, enhance appetite—and in the elderly, help to prevent osteoporosis, colon cancer and heart disease.

A major nutritional problem exists in North America in that the annual consumption of milk per capita continues to decline and currently ranks fourth behind beer, soft drinks and bottled water. Consumers reject milk due to its taste, mouthfeel, fat content, calories—and in susceptible individuals, lactose intolerance. Recommended daily intake levels of vitamins, e.g., A, D, and the B group, as well as minerals, e.g., calcium, magnesium and potassium, cannot be conveniently supplemented by other commercial, non-dairy beverages due to unavailability and potential sensory rejection.

We know of no prior art that discloses any flavored, fortified, lactose free, low calorie, naturally sweetened, carbonated, dairy nutrient beverages that provide supplementation of the levels of essential vitamins, minerals, and amino acids quantitatively comparable to those available in fortified milk. Our beverage also uniquely contains—beneficially—flavonols, anthrocyanins and higher levels of essential minerals such as calcium, potassium and magnesium.

When compared to fat-free milk and carbonated soft drink beverages, the following results are obtained. With respect to units of measurement, unless expressly stated otherwise, as used herein, all liquid components are measured in gallons or fractions thereof and all solid components are measured in grams or fractions thereof. Innovation using Rehydrated Milk Powder:

| | Per 8 oz. | | |
|---|---|---|---|
| | SKIM MILK | SOFT DRINK | DISCLOSURE |
| Calories (kilocalories) | 90 | 130 | 70 |
| Carbohydrates (g) | 13 | 35 | 9 |
| Fat (g) | 0 | 0 | 0 |
| Protein (g) | 8 | 0 | 9 |
| Cholesterol (mg) | ≦5 | 0 | 0 |
| Vitamin A (IU) | 500 | 0 | 500 |
| Vitamin D (IU) | 100 | 0 | 100 |
| Vitamin C (mg) | 2.5 | 0 | 20 |
| B1 (Thiamine) (mg) | 0.17 | 0 | 0.17 |
| B2 (Riboflavin) (mg) | 0.17 | 0 | 0.17 |
| B6 (Pyrodoxine) (mg) | 0.87 | 0 | 0.87 |
| B12 (Cobolamin) (mcg) | 1.34 | 0 | 1.34 |
| Folic Acid (IU) | 0 | 0 | 0.05 |
| Sodium (mg) | 122 | 25 | 115 |
| Calcium (mg) | 301 | 0 | 315 |
| Potassium (mg) | 382 | 0 | 382 |
| Phosphorus (mg) | 247 | 0 | 290 |
| Magnesium (mg) | 27 | 0 | 27 |
| Iron (mg) | 0.07 | 0 | 0.07 |
| Copper (mg) | 0.025 | 0 | 0.025 |
| Carbonation (vols) | 0 | 4.0 | 2.0 |

The chart clearly illustrates how our novel beverage provides, at a minimum, the same qualitative nutritional benefit as milk with respect to essential vitamins, minerals and other beneficial substances naturally present in, or added as fortifications to, milk. Moreover, the levels of some nutritive substances, e.g., calcium, in our beverage exceed the levels found in milk.

U.S. Pat. No. 4,738,856 to Clark et al. discloses calcium, magnesium and potassium aspartate compositions as anti-hypertensive nutrition agents. Clark et al., provides that non-dairy nutritional beverages facilitate and control the transport of calcium ions into the human body while lowering blood pressure and lowering the probability or tendency of incurring colon cancer. Clark et al further discloses that beverages may provide nutritional supplementation of magnesium and/or potassium to the human diet, help reduce premenstrual tension in women, and increase cardiac tolerance in conditions of anoxia.

Clark et al. does not disclose a dairy nutrient beverage prepared from milk that will provide not only large amounts of calcium, magnesium and/or potassium to the human diet, but also supplementation of essential vitamin A, vitamin 0, B complex vitamins, vitamin C, vitamin K, phosphorus, iron and strontium. Clark et al., fails to disclose carbonation along with the infusion of inert food grade gases such as Nitrogen and Argon into a beverage to enhance and increase the solubility of nutrients; to improve the taste of B complex vitamins, minerals and iron in beverage preparations; to enhance the mouth-feel of dairy products to obtain the consumer appeal enjoyed by carbonated and inert gas infused beverages; and to extend the shelf life of dairy products by suppressing the growth of bacteria and spores.

U.S. Pat. No. 5,624,700 to Lyon et al. discloses a process to add carbon dioxide under low shear conditions to an already formed food to produce a semi-solid or solid carbonated food. Lyon et al. does not disclose the carbonation of liquid skim milk or a dry powder preparation of skim milk along with vitamins and minerals to produce an enhanced liquid dairy nutrient product for the supplementation of high levels of essential vitamins and minerals in human nutrition.

What is needed and what we have invented is an all-natural, flavored, fortified, carbonated and inert-gas infused, dairy nutrient beverage that provides high dietary levels of essential vitamins, minerals and amino acids that facilitates their solubility and absorption. The increased dietary levels and improved absorption reduces the tendency to childhood obesity and therefore, cardiovascular disease, diabetes, respiratory disorders, aids in the building of healthy bones and teeth and reduces the probability of developing osteoporosis. The inventive beverage also aids in the prevention of rickets in young people and the development of premenstrual tension (PMS) in women. Folic acid of the B-complex vitamins is supplemented by this disclosure to counter its deficiency in the typical human diet, which may cause megaloblastosis, weight loss, anemia, cardiac enlargement, congestive heart failure—and in pregnant women, development of a fetus with spina bifida.

The beverage supplies a rapidly and highly absorbable source of dairy calcium, magnesium and potassium to the human body without gastric upset and stomach bloating, and thus provides an ideal composition for consumption by humans who are “At Risk” of developing cardiovascular disease, diabetes, and bone diseases such as osteoporosis or osteomalacia. The beverage in an alternate formulation further supplies Vitamin E and Carotenoids such as xeazanthin, Lycopene and lutein to improve cardiovascular health and eyesight and reduce the possibility of the appearance of Gastric Esophageal Reflux Disease (GERD) in the elderly.

Another persistent problem with respect to milk-based beverages is the presence of harmful bacteria such as E. Coli O157.H7, Listeria, Salmonella, Brucella, Campylobacter, Mycobacterium bovis and Yersinia. These bacteria are of deep concern due to their ability to cause illness and death especially in immuno-compensated children, pregnant women, the elderly and others in the population who may be immuno-compensated at the time of milk consumption. Pasteurization has been, for decades, the standard method used to eliminate, or at least minimize the development of bacterial colonies so as to extend the useable shelf-life of milk or milk-based products. Pasteurization, in its simplest form, involves the application of heat to a substance for a specified time to destroy potentially harmful microorganisms.

Although Pasteurization does eliminate bacteria, it is a far from perfect solution for long-term bacterial suppression. We have discovered that to increase the effectiveness of Pasteurization to remove putrefactive bacteria and bacterial spores from the milk-based beverage, the beverage is pre-treated prior to Pasteurization by infusing Argon, Nitrogen, or a mixture of Argon and Nitrogen gasses through the liquid mixture at certain pressures, temperatures and time durations to kill and suppress bacteria formation. Due to the gases' low solubility, each can be off-gassed, recovered and re-used. Combined with the pH-lowering effect of CO₂, the three gas combination surprisingly maximizes bacteria suppression, improves mouth-feel and does not negatively impact product taste.

Variations on the standard Pasteurization method have been developed to further extend the shelf life of products such as milk. One such variation is known as HTST (high temperature short time) Pasteurization that utilizes temperatures of from about 165° F. to about 195° F. and time periods from about 2 seconds to about 30 seconds. Exposure time is inversely proportional to the temperature used.

A second variation is VAT Pasteurization that utilizes temperatures up to about 175° F. for a time period up to about 40 minutes. A yet further variation, UHT (ultra-high temperature) Pasteurization, utilizes temperatures in excess of 215° F. for about 2 to about 5 seconds. UHT Pasteurization is often used to extend the shelf life of chocolate flavored milk drinks from 14 days under refrigeration with standard heat Pasteurization to up to 90 days under refrigeration, and is the method typically used when chocolate milk drinks are to be kept refrigerated on store shelves for over 21 days.

None of the standard heat Pasteurization methods are completely effective against bacterial spores, however. Whether standard or UHT Pasteurization is used, stabilizers and preservatives have to be added and/or Sodium content has to be increased to provide a stable product. On the other hand, if Argon or Nitrogen or a combination thereof are used as a pre-treatment before heat Pasteurization, then the Sodium content of the beverage can be lowered significantly and the beverage will have increased stability. If vitamins and minerals are added to flavored milk drinks that are to be pasteurized, gel binders are also added to stabilize the flavors, colors and nutritive additions. Gel binders present additional problems. It is well known that various gel binders have a significant undesirable laxative effect on susceptible individuals, e.g., children and the elderly. Certain gel binders are also allergenic to susceptible individuals. This is a yet further reason why certain individuals forego drinking even flavored milks.

Problems with off flavors and poor mouth feel may persist when standard methods of UHT Pasteurization are used, even with the use of stabilizers and preservatives. It is known that exposing milk or milk-based products to high heat may degrade certain components such as Riboflavin and Vitamin A, destroy Vitamin C, and caramelize lactose (milk sugar), a disaccharide sugar. The latter effect generates off flavors. What is needed is an alternative to traditional methods of Pasteurization that extends the useful shelf life of milk-based products without causing any degradation in the product, and without needing binders, stabilizers or preservatives.

We have further discovered that by exposing dairy nutrient beverages to CO₂, Argon gas and Nitrogen gas pre-treatment under controlled conditions, the growth of bacteria colonies and spores can be suppressed, and degradation of flavors and nutrients can be reduced if HTST, VAT or UHT Pasteurization is employed and the need for gel binders or stabilizers can be eliminated. In fact, depending on the amounts of CO₂ and Nitrogen and/or Argon gas added, the need for traditional Pasteurization can also be eliminated without any appreciable negative impact on the suppression of bacteria. A further benefit of CO₂ is that it is an acid and therefore serves to buffer the pH of the beverage to reduced spoilage due specifically to, and overgrowth of, aerobes that thrive at higher pH.

### SUMMARY OF THE DISCLOSURE

The beverage disclosed herein serves as a means to enhance the attractiveness of dairy nutrient beverages to make them the new healthful alternative to non-nutritious carbonated soft drinks (CSDs) in the marketplace as well as to provide a delicious source of essential nutritional elements in the daily diet. The nutritional elements are needed to improve the dietary habits of children, reduce obesity, reduce the incidence of cardiovascular disease and high blood pressure in adults, promote the formation of healthy bones and teeth, reduce the incidence of osteoporosis and increase physical vigor, strength and endurance. The beverage also supplies more rapidly absorbed and higher levels of calcium, magnesium and potassium without gastric upset and stomach bloating. This disclosure further provides a pleasant vehicle for the consumption of the recommended daily requirements of essential nutrients by youth who are “AT RISK” of developing childhood obesity, rickets, osteomalacia and other bone diseases.

The beverage described herein incorporates carbonation and/or inert gases to enhance sensory appeal, improve body and mouth-feel, increase acceptability of dairy nutrient beverages, reduce bacterial growth and aid in the stabilization of milk proteins such as Lactalbumin and Casein. In one aspect of the disclosure, the activity of milk lactose is neutralized by the partial mechanical elimination of the lactose with ultrafiltration with the remaining lactose eliminated by the use of nanofiltration or by the addition of enzyme lactase to reduce the remaining disaccharide to its two component monosaccharides (glucose and galactose). This eliminates the possibility of allergic responses such as lactose intolerance in susceptible individuals. Pure crystalline fruit fructose or a high intensity sweetener, or combinations thereof, such as sucralose, or sucralose and acesulfame K, stevia and crystalline fructose can be added to enhance sweetness, taste and flavor. In the event that lactase enzyme is used to remove any residual lactose after ultrafiltration, the amount of sweetener can be reduced by 5-8 percent.

Flavors such as chocolate fudge, chocolate, vanilla, mocha, almond, coconut; latte, butterscotch, coffee and mixtures thereof can be added to enhance taste and acceptability. Fruit flavors such as peach, orange, raspberry, strawberry, Saskatoon berry, blueberry, plains berry, prairie berry and apple as well as mixtures thereof also may be added to enhance taste and acceptability.

In another aspect of the disclosure, a method of making a beverage includes, in one embodiment, the addition of CO₂ and Nitrogen combined with Argon gas to eliminate or effectively reduce the growth of bacterial colonies and spores in the beverage and to reduce degradation of nutrients if HTST or VAT Pasteurization is used. In another embodiment, a variety of gases are used to de-aerate the beverage to enhance the stability of the underlying mixture. In a further embodiment, Nitrogen and Argon gas are added post Pasteurization to enhance beverage stability and shelf life and to reduce the amount of carbon dioxide needed to prevent bacterial and/or mold growth among other benefits. These and other advantages of the disclosure will become apparent from a reading of the following detailed description.

### DETAILED DESCRIPTION OF THE DISCLOSURE

The beverage composition in its broadest aspect comprises liquid skim milk or nonfat dry milk (skim) powder. If skim powder is used, it is reconstituted to skim milk specifications with ultrafiltered tap or reverse osmosis (RO) purified water, or with a mineral solution consisting of Ascorbyl Palmitate, Calcium Picolinate, Magnesium Picolinate and Potassium Picolinate. The use of the mineral solution described above for re-constitution of the dry milk powder results in a formulation that provides significantly increased absorption and assimilation of the Ca, Mg and K ions in the blood stream due to the privileged and selected absorption of Ascorbyl Palmitate, Calcium Picolinate, Magnesium Picolinate and Potassium Picolinate by the villae of the small intestines.

The skim milk, in original liquid or reconstituted powder form, is placed in a closed vessel by passing through a HEPA filter system with 99.997 efficiency to remove any airborne particulates or bacteria larger than 0.2 microns in size. CO₂ gas is pumped into the tank from about 0.5 to about 2 volumes to reduce the pH of the milk down to from about 4.5 to about 5.5. The skim milk is then chilled from about 30° F. to about 33° F. for about one (1) to about six (6) hours at atmospheric pressure under controlled conditions so a percentage of the lactose sugar in the milk is crystallized (approximately 70%) with an average crystal size of from about 200 to about 250 angstroms. The crystallized lactose is removed by ultrafiltration. It should be understood that the percentage of lactose crystallized is not critical to its removal as any lactose remaining after crystallization and mechanical removal is removed by nanofiltration.

After the nanofiltration step is complete, the essentially Lactose-free skim milk is separated further quantitatively by nanofiltration or ultracentrifugation into milk plasma and milk solids. Each fraction is then treated separately as follows: The milk plasma is heated to from about 100 to about 125 degrees centigrade and the milk solids are infused with a blend of Nitrogen-Argon gas. The solids and plasma are next recombined quantitatively and heated to about 90° F. in a steam jacketed kettle or blending tank. Alternatively, the Lactose may be removed by an Ion-Exclusion Chromatographic process providing a significant savings in the cost of Aspergillus Enzyme.

To add sweetness and flavor to the Lactose free, skim milk, natural and/or high intensity sweeteners and/or flavors are added. For each gallon of Lactose-free skim milk prepared in accordance with the foregoing procedure, from about 0.1 to about 10 lbs. of crystalline fructose, from about 0.1 to about 10 oz. of a flavoring agent selected from the group consisting of natural and/or artificial Orange, natural and/or artificial Lemon, natural and/or artificial Strawberry, natural and/or artificial Pomegranate, natural and/or artificial Acai, natural and/or artificial Goji Berry, natural and/or artificial Cola, natural and/or artificial Saskatoon Berry, natural and/or artificial Vanilla, Vanilla extract or Vanillin, natural and/or artificial Grape, natural and/or artificial Lime, natural and/or artificial Ginger, natural and/or artificial Root Beer, natural and/or artificial Birch Beer, natural and/or artificial Sarsaparilla, natural and/or artificial Tangerine, natural and/or artificial Mango, natural and/or artificial Peach, natural and/or artificial Cherry, natural and/or artificial Apple, natural and/or artificial Banana, natural and/or artificial White, Black and/or Green Teas, natural and/or artificial Chocolate, natural and/or artificial Kiwi, natural and/or artificial Coconut, natural and/or artificial Blueberry, natural and/or artificial Raspberry, natural and/or artificial Cranberry, natural and/or artificial Guarbana and/or mixtures thereof are added.

To provide optional coloring to the beverage, coloring agents may be added to the skim milk prepared as described above. For each gallon of lactose-free skim milk, from about 0.001 to about 0.9 of a natural and/or artificial Metachromatic coloring agent may be added. The coloring agent is selected from the group consisting of Red Beet Root, Aronia Fruit Anthocyanins from grapes, Elderberries, Black Carrots, Red Cabbage, Hibiscus, Purple Sweet Potatoes, Blueberries, Saskatoon Berries and/or mixtures thereof. Additional coloring agents include Anatto Extract, Beta Carotene, Beet Juice, Turmeric, FD & C Yellow 5 (Tartrazine), FD & C Yellow 6 (Sunset Yellow), FD & C Blue 1 (Brilliant Blue FCF), FD & C Blue 2 (Indigotine), FD & C Red 3 (Erythrosine), FD & C Red 40 (Allura Red) and/or mixtures thereof.

One benefit of the addition of colorants is as an indicator of product spoilage. If product spoilage occurs due to bacterial growth, a pH change out of the range of from about 6.7 to about 4.9 will take place in the product and lead to a metachromatic color change, indicative of product spoilage.

The resulting blend of the Lactose-free skim milk, sweetener and optional flavoring and/or coloring is well mixed at very low shear while infusing filtered CO₂ gas, Nitrogen or Argon and/or mixtures thereof in a closed container. Prior to administration of the gas, all solid, liquid and gaseous impurities, e.g., oils, aromatic hydrocarbons, aldehydes, sulfur compounds and/or bacteria are removed from the gas. The gas displaces any trapped air present in the blend prior to Pasteurization.

More particularly, Argon gas is bubbled through the liquid mixture at a pressure of from about 30 Kg/cm² to about 50 Kg/cm² at a temperature of from about 33° F. to about 36° F. for from about three (3) to about five (5) minutes. Due to its relatively low solubility, which is close to the solubility of Oxygen, the gas is off-gassed and recovered by raising the temperature of the mixture from about 45° F. to about 48° F. in a continuous flow vacuum centrifuge. Unlike Nitrogen, Argon use is particularly beneficial as it does not form compounds with components of the mixture. Argon simply displaces the Oxygen, which the bacteria need to grow and multiply. Nitrogen, having a solubility similar to Argon, will kill bacteria in any air space above the mixture, or kill bacteria in the mixture if bubbled through the mixture. Like Argon, the Nitrogen bubbles starve the bacteria of Oxygen and will not stay in solution, but unlike Argon, can form compounds, which is why Argon is the more effective bacteria killer. Because Nitrogen is capable of forming compounds (nitrates, nitrites) with other mixture components, it will not remain entirely as a gas, which reduces its effectiveness to kill bacteria relative to Argon. Argon, unlike CO₂, will not stay in solution and will not combine into compounds.

These two Noble gases (Nitrogen and Argon) are surprisingly advantageous over the sole use of CO₂ to suppress bacteria formation. CO₂, however, has its own advantage over Argon and Nitrogen as it lowers the pH of the mixture whereas the Nitrogen and Argon gasses do not. Lowering the pH will attack the anaerobic bacteria that do not require Oxygen. Nitrogen, like Argon, off-gasses with increased temperature at about the same temperature range of about 45° F. to about 48° F. and can be recovered and re-used. The added benefit of the Noble gases is that the Argon and Nitrogen come out of solution and do not impact the mouth-feel or taste of the mixture, whereas the CO₂ remains and provides the desired mouth-feel. The combination of the three gases provides the far superior unexpected combined and desired results of dramatic bacterial suppression, product stability and product acceptability.

By using Argon gas alone, due to its low solubility, or insolubility, the harmful bacteria count per field will be reduced from an expected total bacteria count of up to about 20,000/ml (expected level with conventional Pasteurization alone) to a reduced high level of about 5,000/ml after Argon gas processing plus Pasteurization. When Nitrogen gas is used alone, again due to its low solubility (slightly higher than the solubility of Argon), the bacteria count is expected to drop to about 14,000 bacteria per ml remaining after the Nitrogen treatment combined with Pasteurization. When the beverage is treated with a combination of Argon and Nitrogen gases, the bacteria count should drop to a maximum of about 8,000/ml after Pasteurization. Due to the high cost of Argon gas relative to Nitrogen, the Argon/Nitrogen combination provides a cost effective alternative to impart dramatic long-term bacteria reduction and suppression.

If CO₂ is used or contained in the mixture of gases, as stated, the gas lowers the pH of the mixture and increases the efficiency of Pasteurization in the complete removal of anaerobic bacteria at low Pasteurization temperatures. This preserves high heat labile nutrients (vitamins, enzymes, etc.) contained in the milk base of the blend and avoids carmalization of the added sugar sweetener, e.g. fructose.

The blend is then passed through an HTST Pasteurizer at from about 161° to about 174° F. for about 25 seconds with no homogenization. The resulting product is collected in a sterile container and chilled to from about 32° to about 34° F.

After chilling the product, it is further degassed (air removed) in an air-tight chamber with a mixture of CO₂ gas and Nitrogen-Argon gas where the partial pressure of CO₂ gas is from about 1 to about 99 of the total gas mixture and the partial pressure of Nitrogen is from about 1 to about 99, and where the Argon gas is from 1 to about 99 and where the gas mixture is infused at a pressure of about 10 lb./in.². This assures final removal of any trapped air or Oxygen that can support aerobic bacterial growth. After each degassing, any dissolved air rises to the top and is removed with a bleed-off valve. This procedure may be repeated for up to about five (5) minutes to assure the complete removal of trapped air.

After degassing, filtered CO₂ gas (approximately 100 volumes) is applied to the product through a Sparger to control gas bubble size as it flows from the de-aeration tank to the pasteurized storage tank. The constant flow is adjusted to about 5-15 lb./in.² until a volume of dissolved CO₂ of from about 1.0 to about 3.5 volumes of CO₂ gas is achieved. During the CO₂ gas infusion, the temperature of the product blend must be maintained at about 32° F. to about 34° F. to assure effective and uniform carbonization.

The product is then checked in the pasteurized storage tank for the following final CO₂ gas content and adjusted with additional CO₂, if necessary, before bottling under aseptic conditions into any size containers including 8 oz.-1 qt. PET bottles. The bottling unit must contain a storage bowl to which is applied a uniform CO₂ pressure of about 5 to about 15 lb./sq. in. to keep the product from becoming aerated during the bottling procedure. The resulting product may include per 8 oz., Calcium from about 200 to about 400 mg, protein from about 2 to about 10 g, Anthrocyanins from about 15-45 mg, CO₂ gas from about 1.0 to about 3.5 volumes (the higher the CO₂ content, the lower the pH), pH from about 6.5 to about 4.9 and calories at about 70.

In a further embodiment, from about 0.1 to about 4 volumes of Nitrogen is mixed with from about 0.1 to about 4 volumes of carbon dioxide and from about 0.1 to about 4.0 volumes Argon per 8 oz. of beverage solution. The addition of Nitrogen and Argon with carbon dioxide exhibits several advantages. The Nitrogen/carbon dioxide/Argon mixture provides additional protection from Oxygen pick-up by the beverage. The mixture reduces the amount of carbon dioxide needed to prevent bacterial and/or mold growth, which extends product shelf life. The Nitrogen and Argon components have a low solubility, less than 2, which results in the two gases leaving the beverage when the container is opened. In contrast, the carbon dioxide component has a higher solubility and remains in the beverage to provide the desired sensory benefits.

Another added benefit is that the presence of Nitrogen and Argon reduces the amount of carbon dioxide needed, which, in turn, lowers the acidity without affecting the extended shelf life. Additional benefits include improvement in texture, taste and appearance of the beverage as well as ice-crystal growth inhibition in low temperature beverage storage.

There are at least two ways in which the Nitrogen-Argon gases may be introduced into the beverage. The first is to introduce the Nitrogen and Argon in liquid form. The second is by an inline Sparger gas system to a dairy product. Whichever option is chosen, each is added after any Pasteurization step.

It is to be understood the sequence of adding the ingredients as set forth herein is not essential to the production of the beverage mixture with one exception. It is important that the calcium salt(s) be added to the mixture before the magnesium salt(s) to prevent undesired clumping.

Having described the disclosure, it should be understood that the foregoing description of the disclosure is intended merely to be illustrative thereof and that other modifications, embodiments and equivalents may be apparent to those who are skilled in the art without departing from its spirit.

Having thus described the disclosure, what we claim as new and desire to secure by United States Letters Patent is:

1. A method of making a dairy nutrient beverage comprising the steps of:
providing skim milk containing lactose;
chilling the milk to crystallize the lactose;
filtering the milk;
adding a sweetener to the milk to form a blend;
mixing the blend at low shear;
infusing a pre-pasteurization mixture of Nitrogen-Argon gas into the blend;
pasteurizing the blend; and,
infusing a mixture of CO₂ gas and Nitrogen-Argon gas into the blend.

2. The method of claim 1 further comprising the step of infusing a second volume of CO₂ into the blend.

3. The method of claim 1 wherein the milk is chilled from about 30° F. to about 33° F.

4. The method of claim 3 wherein the milk is chilled from about three to about six hours at atmospheric pressure.

5. The method of claim 1 wherein about 70 percent of the lactose is crystallized or removed by Ion-Exclusion Chromatography.

6. The method of claim 5 further comprising filtering the milk to remove the crystallized lactose and form a permeate with uncrystallized lactose.

7. The method of claim 6 further comprising adding lactase enzyme to the permeate to hydrolize the uncrystallized lactose.

8. The method of claim 7 wherein about 3.32 ml/gal of lactase enzyme is added to the permeate.

9. The method of claim 7 further comprising incubating the permeate and lactase enzyme at about 40° F. for about 20 hours to essentially complete the hydrolysis of the uncrystallized lactose.

10. The method of claim 7 further comprising heating the permeate to about 90° F.

11. The method of claim 10 wherein the permeate is heated in a steam jacketed kettle or blending tank.

12. The method of claim 11 further comprising using an HTST Pasteurizer to pasteurize the permeate from about 161° to about 170° F. for about 15 to about 25 seconds to produce a pasteurized product.

13. The method of claim 12 further comprising collecting the pasteurized product in a sterile container and chilling the product to from about 32° to about 35° F.

14. The method of claim 13 wherein the mixture of CO₂ and Nitrogen-Argon comprises a CO₂ partial pressure from about 1 to about 99 of the total gas mixture and a Nitrogen partial pressure of about 99 to about 1 of the total gas mixture.

15. The method of claim 14 further comprising infusing the gas mixture at a pressure of about 10 lb.lin².

16. The method of claim 14 further comprising repeating the gas mixture infusion up to about 5 minutes.

17. The method of claim 2 wherein the second volume of C0₂ is applied with a constant flow adjusted to about 10 lb.lin² until a volume of dissolved CO₂ of from about 1.0 to about 3.5 volumes of CO₂ gas is achieved.

18. The method of claim 17 further comprising maintaining the temperature from about 32° to about 35° F.

19. The method of claim 1 wherein the pre-pasteurization mixture further comprises CO₂ infused into the blend.

20. The method of claim 19 further comprising the step of infusing a second volume of CO₂ into the blend.
